(19) United States
(12) Patent Application Publication
(10) Pub. No.: US 2008/0270819 A1
(43) Pub. Date: Oct. 30, 2008

(54) Uncorrelated actions using a distributed system

(76) Inventor: Bruce Hamilton, Menlo Park, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/796,315

(22) Filed: Apr. 27, 2007

(51) Int. Cl. G06F 1/14

(52) U.S. Cl. 713/502

(57) ABSTRACT

A distributed system that uses distributed synchronized time to perform uncorrelated actions. A distributed system according to the present teachings includes a set of nodes each having a synchronized real-time clock. The nodes use the synchronized real-time clocks to trigger a set of uncorrelated actions from the nodes.

### BACKGROUND

A variety of actions may be taken in an environment of interest using a distributed system. Examples of actions that may be taken in an environment using a distributed system include obtaining measurements in the environment and applying stimuli in the environment.

A distributed system may include a set of nodes that communicate with one another via a communication network. The nodes in a distributed system may obtain measurements from an environment and apply stimuli in the environment. A distributed system may include a central controller that sends commands to the nodes that cause the nodes to take actions. Alternatively, each node may itself initiate measurements and stimuli.

It may be desirable under of a variety of circumstances to take uncorrelated actions in an environment. An uncorrelated action may be defined as an action that does not correlate to events and behaviors in the environment and that does not correlate with other actions taken in the environment.

One example of taking uncorrelated actions in an environment is obtaining measurements in the environment at random times. Another example of taking uncorrelated actions in an environment is applying stimuli in the environment at random times.

Uncorrelated actions may be beneficial in an environment in which the consequences of the actions may be skewed by dependencies among the actions or dependencies on the environment. For example, obtaining measurements at random times may be useful for avoiding aliasing that might otherwise distort a view of an environment having periodic properties.

Attempts to undertake uncorrelated actions using a distributed system may be defeated by the characteristics of the distributed system. For example, the timing characteristics of a communication network may cause commands that are randomly generated by a central controller in a distributed system to nevertheless reach the nodes of the distributed system in a time aligned fashion, thereby creating correlation among the actions triggered by the commands. In addition, any differences in the clock speeds of the nodes in a distributed system may cause actions to be taken more often in the faster nodes than in the slower nodes, thereby causing correlations.

### SUMMARY OF THE INVENTION

A distributed system is disclosed that uses distributed synchronized time to perform uncorrelated actions. A distributed system according to the present teachings includes a set of nodes each having a synchronized real-time clock. The nodes use the synchronized real-time clocks to trigger a set of uncorrelated actions from the nodes.

Other features and advantages of the present invention will be apparent from the detailed description that follows.

### BRIEF DESCRIPTION OF THE DRAWINGS

The present invention is described with respect to particular exemplary embodiments thereof and reference is accordingly made to the drawings in which:

FIG. 1 shows a distributed system that incorporates the present teachings;

FIG. 2 shows an embodiment of a distributed system that triggers a set of actions using a set of action trigger signals;

FIG. 3 shows an embodiment of a distributed system in which a node obtains a time value in a message from a central controller;

FIG. 4 shows an embodiment of a distributed system in which a node includes a random time generator.

### DETAILED DESCRIPTION

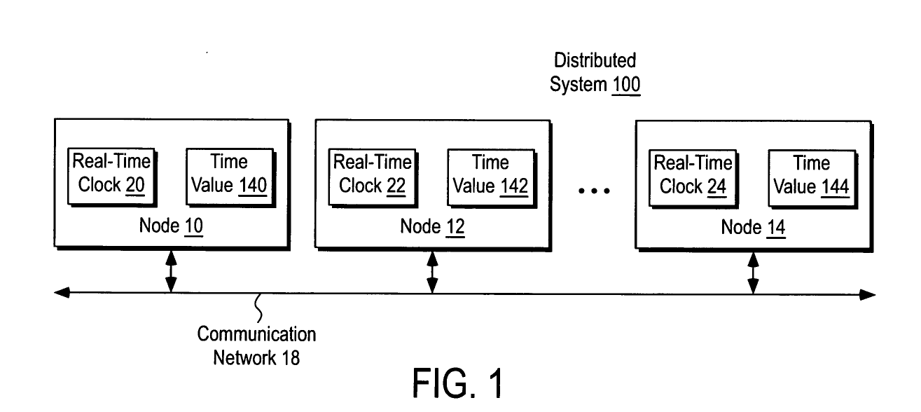

FIG. 1 shows a distributed system 100 that incorporates the present teachings. The distributed system 100 includes a set of nodes 10-14 having a set of respective real-time clocks 20-24. The times in the real-time clocks 20-24 are synchronized with respect to one another. The nodes 10-14 use the synchronized times in the real-time clocks 20-24 and a set of respective time values 140-144 to trigger a set of actions.

The time values 140-144 are generated such that the actions by the nodes 10-14 are not correlated to events and behaviors in an environment of interest. For example, the time values 140-144 may be generated to avoid a periodic relationship between the time values 140-144 and any periodic properties of an environment of interest. The time values 140-144 may also be generated to avoid correlation among the actions, e.g. to avoid periodicity in the time values 140-144. In one embodiment, the time values 140-144 are random time values.

The nodes 10-14 may receive the time values 140-144 via the communication network 18. Alternatively, the nodes 10-14 may generate the respective time values 140-144 internally.

The real-time clocks 20-24 may be synchronized using any time synchronization protocol, mechanism, etc. Examples include IEEE 1588 (IEEE Standard No: 61588: 2004 (1588-2002) ISBN: 2-8318-7541-2) and Network Time Protocol (NTP). The times generated by the real-time clocks 20-24 and the time values 140-144 may be times of day in any format.

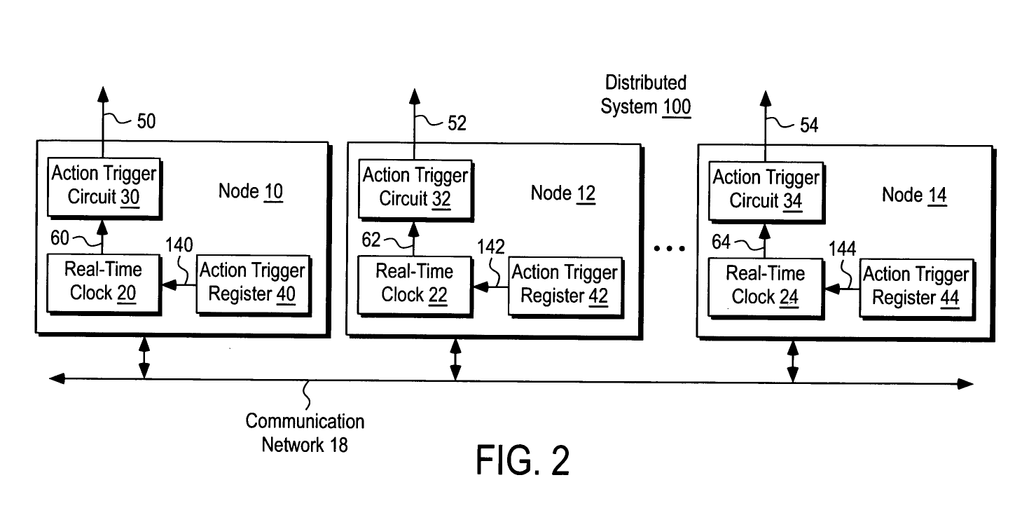

FIG. 2 shows an embodiment of the distributed system 100 that triggers a set of actions using a set of action trigger signals 50-54. Each action trigger signal 50-54 causes a respective action to be taken in an environment of interest. The actions triggered by the action trigger signals 50-54 may include any combination of measurement actions and stimulus actions.

Each node 10-14 in this embodiment includes a respective action trigger register 40-44 that holds the respective time value 140-144. Each node 10-14 in this embodiment includes a respective action trigger circuit 30-34. Each action trigger circuit 30-34 asserts the respective action trigger signal 50-54 when a respective time value 60-64 from the respective real-time clock 20-24 reaches the respective time value 140-144 stored in the respective action trigger register 40-44. For example, the action trigger circuit 30 in the node 10 asserts the action trigger signal 50 when the time value 60 from the real-time clock 20 reaches the time value 140 stored in the action trigger register 40.

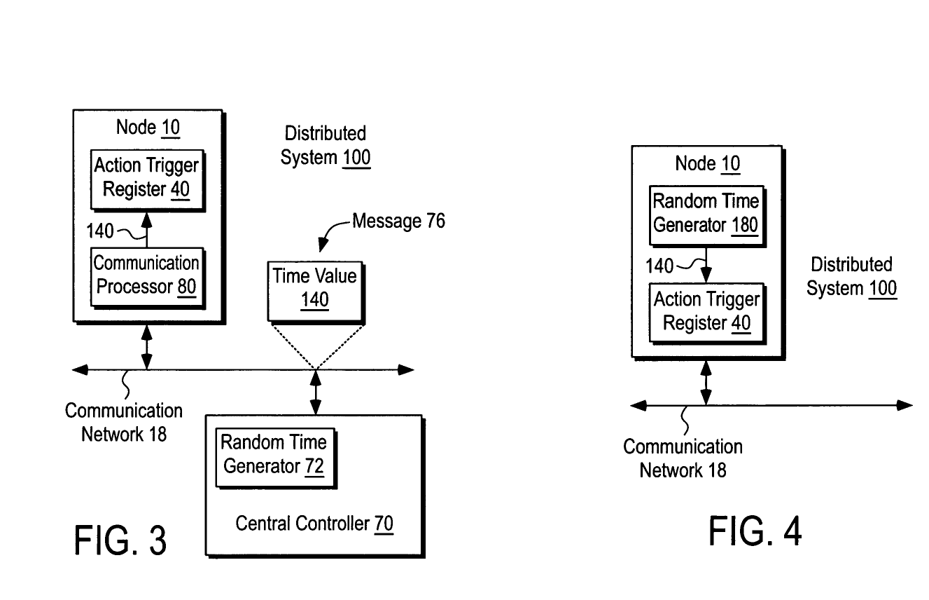

FIG. 3 shows an embodiment of the distributed system 100 in which the node 10 obtains the time value 140 in a message 76 from a central controller 70. The central controller 70 includes a random time generator 72 that generates the time value 140. The message 76 may include a channel identifier for an embodiment in which the node 10 includes multiple channels for triggering actions.

The node 10 in this embodiment includes a communication processor 80 that obtains the message 76 via the communication network 18 and that writes the time value 140 into the action trigger register 40. The communication processor 80 includes the appropriate hardware/software mechanisms, protocol stack, for performing communication via the communication network 18.

FIG. 4 shows an embodiment of the distributed system 100 in which the node 10 includes a random time generator 180 that generates the time value 140 and that stores the time value 140 in the action trigger register 40. The random time generator 180 may be a processor that generates the time value 140 in code or may make use of a hardware number generator, e.g. a random number generator.

The action trigger register 40 may store multiple time values for triggering multiple actions via the action trigger signal 50. The node 10 may generate multiple action trigger signals each with its own random schedule.

One example of environment of interest in which actions may be taken according to the present teachings is a traffic system. One example of an action in a traffic system is taking a picture at an intersection. In the following example, the intersection is outside of a school having a lunch recess from noon until 1:00 PM and the school gets out at 3:00 PM. A picture may be taken at an intersection 6 times per day, e.g. every 4 hours. If a picture is taken at 11:45 AM and 3:45 PM it will falsely appear as though the intersection is never busy and this mistake will repeat each day. An increase in the frequency of picture taking to 9 times per day yielding pictures at 11:45 AM and 2:25 PM would still miss recess and school closing while causing an undesirable 50% increase in picture taking expenses. The problem is that the pictures are correlated with the school schedule since both are correlated to the daily cycle. One way to avoid this correlation is to sample at an irrational multiple of 1 per day. If pictures are taken at 2π times per day, i.e. every 3.8197 hours, it costs about the same as 6 samples per day but will not take two pictures at the same time of day. This yields an unbiased view of the intersection.

If a first camera and a second camera take a picture at the intersection every 6 hours so that the second camera takes pictures ½ hour before the first camera, pictures will be taken at 11:15 AM and 2:15 PM and still miss the busy times. Even if the second camera takes pictures halfway between pictures by the first camera, the resulting pictures at 1:45 AM and 5:45 PM still miss the busy times. Therefore, it is desirable to uncorrelate pictures by the second camera from the school's schedule. The same technique may be used as with the first camera (discussed above) but it is more desirable that the pictures from the second camera provide new information. One way to uncorrelate pictures by the second camera with pictures by the first camera and the school is to choose a different irrational number. Taking pictures with the first camera and the second camera at independent random times accomplishes the same effect.

Random actions have the advantage that actions are uncorrelated with the environment no matter what the period of the thing being sampled (or any of its periods if it is complicated). The same algorithm may be used for all sensors. On the other hand, it may be less expensive to build devices that sample at a fixed rate in comparison to devices that sample randomly. If the relevant period in the environment of interest is known, an irrational multiple may be used that is just below the maximum rate of a sensor, thereby yielding more samples per unit time in comparison to random sampling.

The foregoing detailed description of the present invention is provided for the purposes of illustration and is not intended to be exhaustive or to limit the invention to the precise embodiment disclosed. Accordingly, the scope of the present invention is defined by the appended claims.

What is claimed is:

1. A distributed system comprising a set of nodes each having a synchronized real-time clock such that the nodes use the synchronized real-time clocks to trigger a set of uncorrelated actions.

2. The distributed system of claim 1, wherein the uncorrelated actions are triggered using a set of time values.

3. The distributed system of claim 2, wherein the time values are generated to avoid a correlation of the uncorrelated actions with an environment.

4. The distributed system of claim 2, wherein the time values are generated to avoid correlation among the time values.

5. The distributed system of claim 2, wherein the time values are random time values.

6. The distributed system of claim 2, wherein the nodes receive the time values via a communication network.

7. The distributed system of claim 2, further comprising a central controller that generates the time values and sends the time values to the nodes via a communication network.

8. The distributed system of claim 2, wherein the nodes generate the time values.

9. A method for performing a set of uncorrelated actions using a distributed system, comprising:
providing each of a set of nodes in the distributed system with a synchronized real-time clock;
triggering the uncorrelated actions in the nodes using the synchronized real-time clocks.

10. The method system of claim 9, wherein triggering comprises triggering using a set of time values.

11. The method of claim 10, further comprising generating the time values to avoid a correlation of the uncorrelated actions with an environment.

12. The method of claim 10, further comprising generating the time values to avoid correlation among the time values.

13. The method of claim 10, wherein the time values are random time values.

14. The method of claim 10, further comprising sending the time values to the nodes via the communication network.

15. The method of claim 10, further comprising generating the time values in a central controller and sending the time values to the nodes via a communication network.

16. The method of claim 10, further comprising generating the time values in the nodes.

17. A node for a distributed system, comprising:
a synchronized real-time clock;
trigger circuit that uses the synchronized real-time clock to trigger an uncorrelated action in the distributed system.

18. The node of claim 17, wherein the trigger circuit triggers the uncorrelated action in response to a time value.

19. The node of claim 18, further comprising a communication processor that receives the time value via a communication network.

20. The node of claim 18, further comprising a number generator that generates the time value.
